(19) United States
(12) Patent Application Publication
(10) Pub. No.: US 2008/0217827 A1
(43) Pub. Date: Sep. 11, 2008

(54) CLAMPING FIXTURE

(75) Inventors: YU-LIN LIU, Shenzhen (CN); ZHONG-SHAO LUO, Shenzhen (CN); XUE-JI LUO, Shenzhen (CN); QIANG ZENG, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/828,360

(22) Filed: Jul. 26, 2007

(30) Foreign Application Priority Data
Mar. 9, 2007 (CN) 200720200132.4

(51) Int. Cl. B25B 5/14

(52) U.S. Cl. 269/41

(57) ABSTRACT

A clamping fixture (1) is used for clamping an enclosure of a device. The clamping fixture includes a first clamp member (12), a second clamp member (13), and an adjusting pole (5). The first clamp member includes a first clamping portion (127) with a first contacting surface. The second clamp member includes a second clamping portion (137) with a second contacting surface. The second contacting surface is parallel to the first clamping portion. The first and the second clamping portions are configured for cooperatively clamping the enclosure of the device between the first and the second contacting surfaces. The adjusting pole has a first end threadedly engaged in the first clamp member and an opposite second end threadedly engaged in the second clamp member. The adjusting pole is adjustably movable relative to the first and the second clamp members along a lengthwise direction thereof.

### BACKGROUND OF THE INVENTION

1. Field of the Invention

The present invention relates to a clamping fixture, and more particularly to an adjustable clamping fixture for clamping a product.

2. Description of Related Art

Clamping fixtures are used in a wide variety of applications. One application in particular where such devices are helpful is in a drop test of a product. The product may be a computer or an electronic device. A product is dropped from a predetermined height to the ground for testing the products' resistance to damage. Clamping fixtures are clamped at corners of an enclosure for the device.

One group of clamping fixtures usually includes four clamping fixtures for clamping four corners of an enclosure. A clamping width of a conventional clamping fixture is fixed. The clamping fixtures may require redesign after a test due to different sizes of the various devices to be tested, which is costly and time consuming.

What is needed, therefore, is a product structured adjustable clamping fixture.

### SUMMARY

A clamping fixture is used for clamping an enclosure of a device. The clamping fixture includes a first clamp member, a second clamp member, and an adjusting pole. The first clamp member includes a first clamping portion with a first contacting surface. The second clamp member includes a second clamping portion with a second contacting surface. The second contacting surface is parallel to the first clamping portion. The first and the second clamping portions are configured for cooperatively clamping the enclosure of the device between the first and the second contacting surfaces. The adjusting pole has a first end threadedly engaged in the first clamp member and an opposite second end threadedly engaged in the second clamp member. The adjusting pole is adjustably movable relative to the first and the second clamp members along a lengthwise direction thereof.

Other advantages and novel features of the present invention will become more apparent from the following detailed description of a preferred embodiment when taken in conjunction with the accompanying drawings, in which:

### BRIEF DESCRIPTION OF THE DRAWINGS

FIG. 1 is a partially exploded, isometric view of a clamping fixture of a preferred embodiment of the present invention, the clamping fixture comprising a first clamp member, a second clamp member, and an actuating pole adjustably attached to the clamp members;

FIG. 2 is similar to FIG. 1, but shown from another aspect;

FIG. 3 is an assembled view of FIG. 1; and

FIG. 4 is similar to FIG. 3, but shown from another aspect.

### DETAILED DESCRIPTION OF THE EMBODIMENT

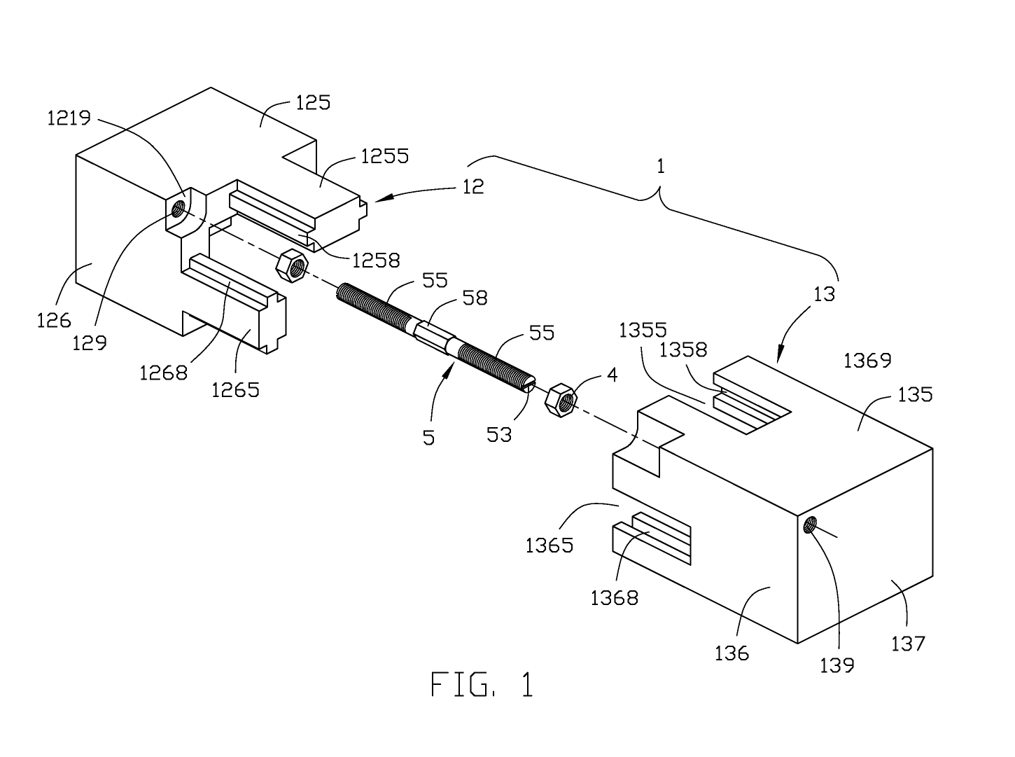

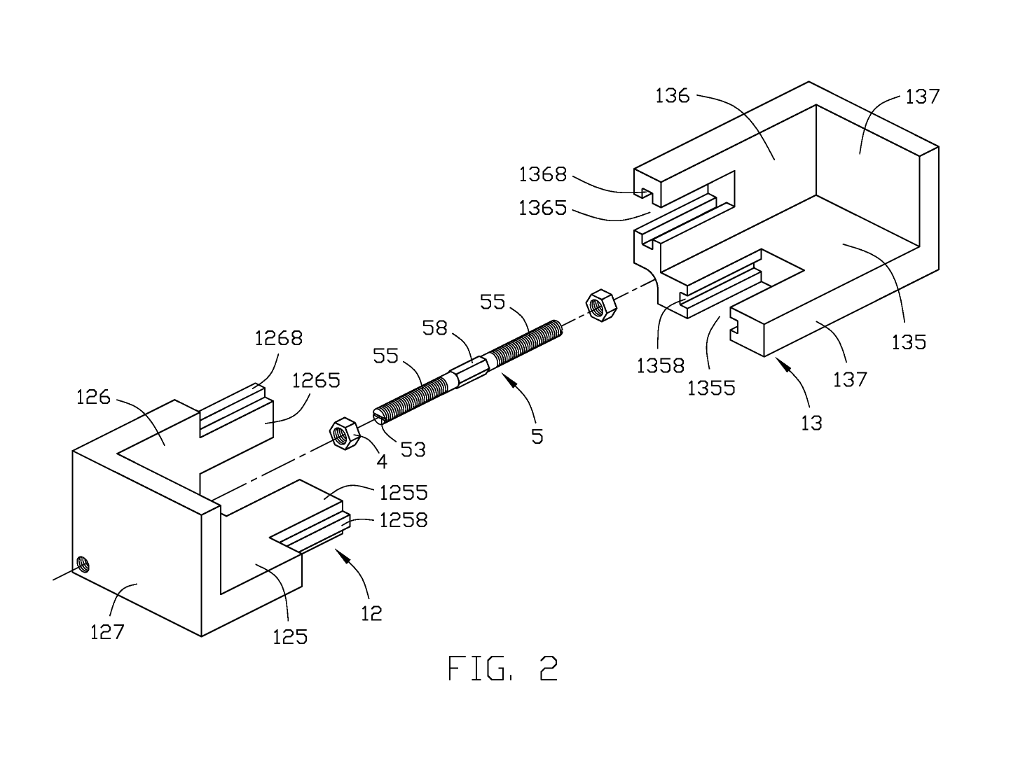

Referring to FIG. 1, a clamping fixture 1 is provided for clamping an enclosure, such as a computer enclosure, in a drop test. The clamping fixture 1 includes a first clamp member 12, a second clamp member 13, and an adjusting pole 5 serving as an actuating mechanism connecting the first clamp member 12 to the second clamp member 13.

Referring also to FIG. 2, the first clamp member 12 has a first wall 125, a second wall 126 extending perpendicularly from the first wall 125, and a third wall functioning as a clamping portion 127 perpendicular to the first wall 125 and the second wall 126. The second clamp member 13 has a first wall 135, a second wall 136 perpendicular to the first wall 135, and a third wall functioning as a clamping portion 137 perpendicular to the first wall 135 and the second wall 136. Each of the clamping portions 127 and 137 has a contacting surface for abutting a surface of the enclosure. Extending portions 1255, 1265 respectively protrude from the first wall 125 and the second wall 126. Pairs of elongated guiding limb 1258, 1268 are respectively formed on each of two lateral sides of each extending portion 1255, 1265. Recesses 1355, 1365 are defined in the first and the second walls 135, 136 corresponding to the extending portions 1255, 1265. Pairs of guiding slots 1358, 1368 are defined in two opposite inner surfaces bounding the recesses 1355, 1365 for receiving the corresponding guiding limbs 1258, 1268 of the extending portions 1255, 1265. Screw holes 129, 139 are respectively defined in conjunction areas of the first wall 125 and the second wall 126, and the first wall 135 and the second wall 136.

The adjusting pole 5 has two threaded end portions 55 and an actuating portion 58 with a hexagonal section at a middle portion thereof. A driving slot 53 is defined at the distal end of each threaded portion 55. A pair of holding nuts 4 is provided for the adjusting pole 5 to adjust position of the clamp members 12 and 13 relative to each other.

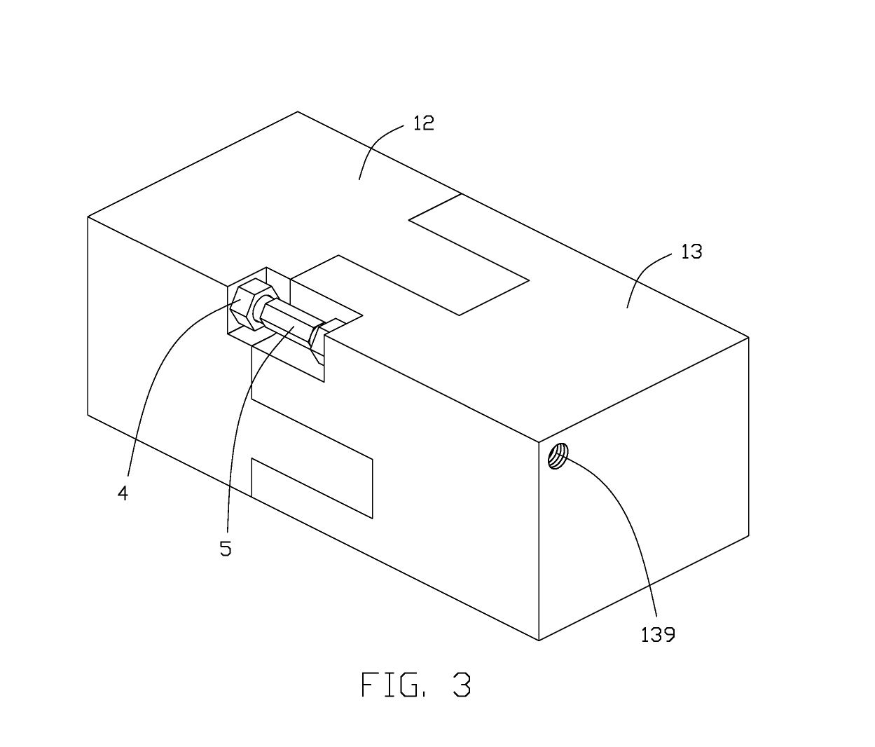

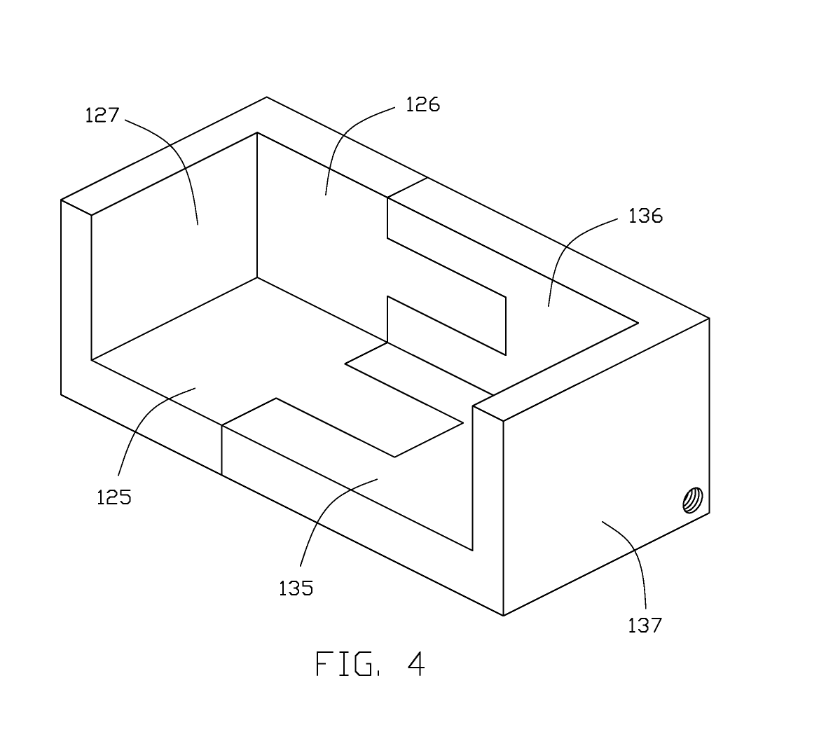

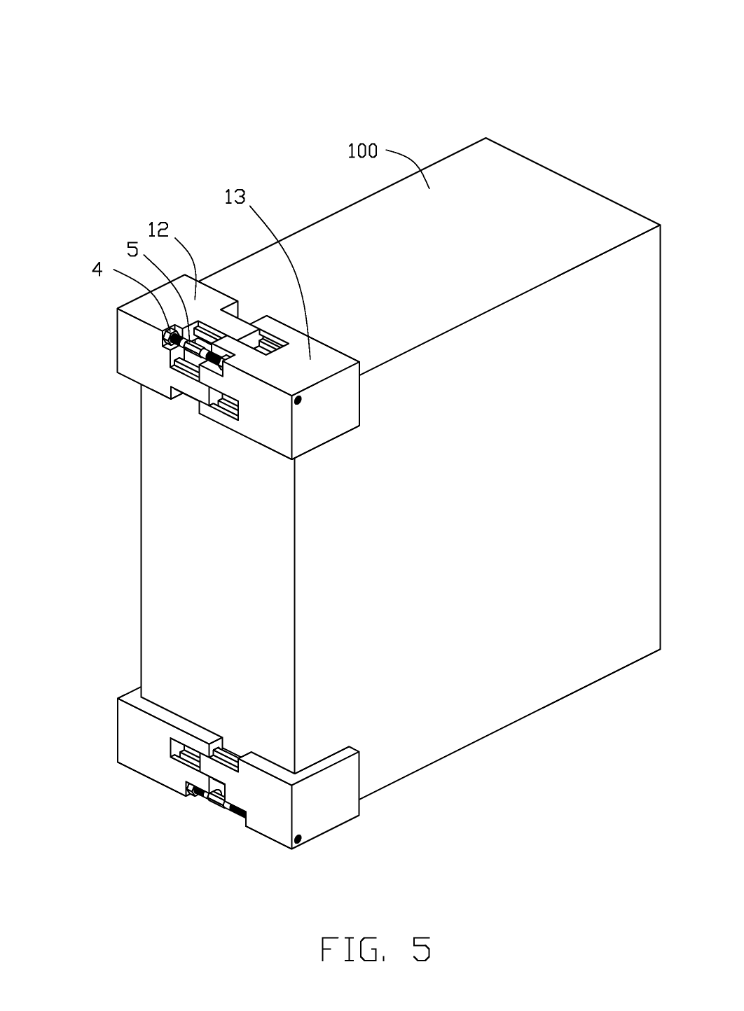

Referring also to FIG. 3 and FIG. 4, when assembling the clamping fixture, the holding nuts 4 are respectively screwed to the threaded portions 55 of the adjusting pole 5. The threaded portions 55 are respectively screwed into the corresponding screw holes 129, 139 of the first clamp member 12 and the second clamp member 13. At the same time, the extending portions 1255, 1265 are received in the corresponding recesses 1355, 1365 with the guiding limbs 1258, 1268 sliding into the corresponding guiding slots 1358, 1368.

Referring also to FIG. 5, when using the clamping fixture 1, rotating the adjusting pole 5 in one of a clockwise direction and an anticlockwise direction, the adjusting pole 5 drives the first clamp member 12 and the second clamp member 13 to move away from each other. Thus, a clamp width of the clamping fixture 1 can be adjusted. The champing fixture 1 is adjusted to receive a corner of an enclosure 100, then tightened to firmly clamp the corner thereof. The holding nuts 4 are rotated to move to abut against the corresponding first clamp member 12 and the second clamp member 13 thereby preventing the adjusting pole 5 from making unwanted rotational movement. Thus, the clamping fixture 1 is precisely attached to the product 100.

The adjusting pole 5 also can be driven by a screwdriver from an outer side of the screw holes 129, 139 with a head of the screwdriver engaged with the driving slot 53.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A clamping fixture for clamping an enclosure of a device, the clamping fixture comprising:
a first clamp member comprising a first clamping portion with a first contacting surface;
a second clamp member comprising a second clamping portion with a second contacting surface parallel to the first contacting surface, the first and the second clamping portions being configured for cooperatively clamping the enclosure of the device between the first and the second contacting surfaces thereof; and
an adjusting pole having a first end threadedly engaged in the first clamp member and an opposite second end threadedly engaged in the second clamp member, and the adjustably pole being adjustably movable relative to the first and the second clamp members along a lengthwise direction thereof.

2. The clamping fixture as described in claim 1, wherein a holding nut is screwed to the adjusting pole for holding a position of the adjusting pole relative to the first clamp member or the second clamp member.

3. The clamping fixture as described in claim 1, wherein an actuating portion with a hexagonal section is formed at a middle portion of the adjusting pole for facilitating manipulation of the adjusting pole.

4. The clamping fixture as described in claim 1, wherein a driving slot is defined at a distal end of the adjusting pole, so that the adjusting pole can be driven by a screwdriver from the distal end thereof.

5. The clamping fixture as described in claim 1, wherein an extending portion with at least one guiding limb extends from one of the first clamp member and the second clamp member, and a recess with at least one guiding slot for receiving the extending portion is formed on the other one of the first clamp member and the second clamp member.

6. The clamping fixture as described in claim 1, wherein each clamp member has a first wall and a second wall, and each clamping portion transversal to the first wall and the second wall.

7. A clamping fixture comprising:
a first clamp member;
a second clamp member movable relative to the first clamp member in a first direction; and
an actuating mechanism precisely adjusting a distance between the first clamp member and the second clamp member, the actuating mechanism being configured for holding the position of the first clamp member relative to the second clamp member.

8. The clamping fixture as described in claim 7, wherein the actuating mechanism comprises an adjusting pole, the adjusting pole has opposite threaded end portion for screwing to the first clamp member and the second clamp member.

9. The clamping fixture as described in claim 8, wherein the actuating mechanism further comprises a holding nut screwed to the adjusting pole for holding the position of the adjusting pole relative to the first clamp member and the second clamp member.

10. The clamping fixture as described in claim 8, wherein an actuating portion with a hexagonal section is formed at a middle portion of the adjusting pole for facilitating driving of the adjusting pole.

11. The clamping fixture as described in claim 8, wherein a driving slot is defined at a distal end of the adjusting pole, so that the adjusting pole can be driven by a screwdriver from the distal end thereof.

12. The clamping fixture as described in claim 7, wherein an extending portion with at least one guiding limb extends from one of the first clamp member and the second clamp member, and a recess with at least one guiding slot for receiving the extending portion is formed on the other one of the first clamp member and the second clamp member.

13. The clamping fixture as described in claim 7, wherein each clamp member has a first wall and a second wall, and each clamping portion transversal to the first wall and the second wall.

14. A clamping device comprising:
an elongated post having a first threaded portion, an opposite second threaded portion and an intermediate manipulating portion, the manipulating portion being free of thread thereon;
a first clamp member threaded engaged with the first threaded portion of the post, the first clamp member having a protrusion extending in a lengthwise direction of the post; and
a second clamp member threaded engaged with the second threaded portion of the post, the second clamp member having a recess for engagingly receiving the protrusion;
wherein the first and the second threaded portions of the post are structured in a manner such that the post is rotatable relative to the first and the second clamp member in both a first direction so as to decrease a distance between the first and the second clamp member and an opposite second direction so as to increase the distance therebetween.

15. The clamping device as described in claim 14, wherein at least one of the first and the second clamp members has a threaded through hole for receiving the post therein.

16. The clamping device as described in claim 14, further comprising a screw nut threaded engaged with the post between the first and the second clamp members.
